(19) United States
(12) Patent Application Publication
(10) Pub. No.: US 2010/0031367 A1
(43) Pub. Date: Feb. 4, 2010

(54) Single File Rich Media Package Portable Across Multiple Devices

(76) Inventors: Thomas Joseph Leonard, Kailua-Kona, HI (US); Michael Jai Feinberg, Kapa'A, HI (US)

Correspondence Address: MARSH, FISCHMANN & BREYFOGLE LLP, 8055 East Tufts Avenue, Suite 450, Denver, CO, 80237, US

(21) Appl. No.: 12/301,613

(22) PCT Filed: May 29, 2007
(86) PCT No.: PCT/IB2007/052005

§ 371 Date: Oct. 16, 2009

Related U.S. Application Data
(60) Provisional application No. 60/809,837, filed on Jun. 1, 2006.

(51) Int. Cl. G06F 3/01; G06F 21/00; G06F 17/30; G06Q 30/00; G06Q 50/00

(52) U.S. Cl. 726/26; 715/716; 707/104.1; 705/14.53; 705/27; 707/E17.009

(57) ABSTRACT

A process, format, and computer software for collecting a broad range of digital media objects, and storing them in a single, rich media container file, for simplified distribution and integrated playback. The resulting file can take on the dynamics of its intended use, so the music-oriented file may be album-centric, track oriented, and contain integrated cover art and links to the artist website, while a movie-oriented file may be video-centric, scene oriented, and contain integrated promotional art and links to actor biographies and photographs. Regardless of the usage, the resulting file provides an end user with an integrated, rich media viewing and listening experience, all in one place, and portable across multiple computers, mobile devices, and other platforms. The process and computer program for creating the rich media file also embeds digital rights management of the underlying content, and can enable both the publishers and users of the rich media file to customize their respective files with additional or unique content.

### TECHNICAL FIELD

The invention relates generally to the collection, formatting, editing, and management of digital content into a packaged rich media file that can be played on multiple devices, and customized by the content provider, publisher, or user. In particular, it describes the bundling of various digital media objects into a dotAlbum™, dotMovie™, dotBook™, dotLesson™, dotPromo™, dotGift™, or other portable, comprehensive, and integrated rich media experiences.

### BACKGROUND ART

With the advent of computer and broadband technology, the music and broader entertainment industry has evolved in its ability to deliver music, movies, and other content in an increasingly rich and more satisfying experience to consumers. Early entertainment product was generally delivered in physical form on vinyl records, cassette tapes, and video tapes. This media lent itself to music-only or video-only playback, on a sequential basis, and with any additional artwork or related content external to the respective storage medium. The invention of compact disks (CD's) and digital video disks (DVD's) later enhanced the user experience, primarily by enabling both the random selection of material as well as the addition of music, video, and other digital content to the work itself, at higher quality, and with much more storage capacity.

With the invention of advanced computer processors and increased network bandwidth, entertainment content is moving into a more ‘digital only’ form, through direct transmission of individual media files to home computers and other devices, where they are unpacked and rendered for listening and viewing pleasure by any one of dozens of ‘media players’ resident on the respective devices.

The most commonly used media players today are Microsoft's Windows Media Player, Apple's iTunes, and RealNetwork's RealPlayer, though there are literally hundreds of software programs built for the express purpose of showing or playing digital content for the end consumer. Most work essentially the same way: They usually uncompress the respective audio or video file and present them to the user for listening or viewing, along with features to control the volume, playback, and other aspects of the media experience. Because these technologies evolved as ‘single use’ systems (i.e., for audio, or video) they generally process individual files at a time, including such formats as MPEG Audio Layer 3 (Mp3), Advanced Audio Codec (AAC), and Windows Media Audio and Video (WMA and WMV, respectively). Some media players, like Apple's QuickTime, support more advanced media files that contain audio and video combinations. In addition, there are Play List file types, including MPEG Version 3 Universal Resource Locator (M3u) and Icecast or Shoutcast Play List (PLS) that allow specification of multiple audio or video tracks in a single file, and can be interpreted by various media players on the market.

No known media player or media formatting, editing, and file creation program enables the easy creation, customization, and publishing of a single rich media file that contains as many different media objects, integrated and secured in one container portable across multiple computer systems and devices. No known media creation software includes the variable ‘usage-centric’ paradigm of enabling users or publishers to create rich media container files that are tailored for the particular intended usage, such as a ‘dotAlbum’, or a ‘dotMovie’, or a ‘dotBook’. In addition, the EP3 file format that is also the subject of this invention provides the first known instance of a rich media viewing and listening experience that includes multiple audio files, video files, photographic images, local web sites, external web sites, RSS feeds, and artwork all in one place, supported by imbedded digital rights management, and playable across multiple operating systems and devices.

### DISCLOSURE OF INVENTION

### Technical Problem

The present invention provides the process, computer software, and file specifications for the collection, formatting, and editing of individual media objects into a single, packaged, rich media container file. The specifications for the process and computer software used to collect, format, and edit rich media objects is part of this submission. The specifications for the resulting rich media container file are also part of this submission, and represent a single file containing multiple media objects integrated into a complete viewing and listening experience, and portable as one package across multiple computer, mobile, and other devices. This file can be distributed to end-user computer systems where a software program is able to unpack and render the media objects in a coordinated entertainment experience, and where in certain circumstances, the end user can customize the contents of the received file and re-publish them as their own unique experience.

The media collection, formatting, and editing computer program that is part of this invention may contain one or more of any or all of the following functions:
Create/Edit Audio & Video
Tracks Create/Edit Artwork
Create/Edit Websites
Create/Edit Slide Shows
Create/Edit Lessons
Create/Edit Text
Create/Edit Advertising
Create/Edit Coupons
Create/Edit Overview
Create/Publish Media Bundle

While the detailed description of this invention emphasizes only some of these functions, it is the intent of the present invention to provide this list as well as other ‘usage-centric’ functionality as described in the summary for the resulting rich media container file.

The rich media container file that is part of this invention may contain one or more of any or all of the following types of digital media objects:
Audio files
Video files
Photographic images
Local liner notes
Local web sites
Internet web sites
RSS news feeds
Album cover and jewel case art
Advertising

### Technical Solution

In the following description, for purposes of explanation, numerous details are set forth, such as schematics, flowcharts, software interfaces, and file configurations, in order to provide an understanding of one or more embodiments of the present invention. However, it is and will be apparent to one skilled in the art that these specific details are not required in order to practice the present invention, nor do they limit the present invention to any one ‘usage centric’ experience.

FIG. 1 is a schematic diagram illustrating a system 100 that integrates the collection, formatting, and editing of various rich media objects into one EP3 rich media container file, for viewing and listening on an end-user rich media program.

The system 100 preferably comprises various rich media files 110 (1.1 through 1.8), described earlier as music, video, photographs, text, and other files in different formats and codecs, along with local and internet web addresses, all being ingested, formatted, edited, and integrated by rich Media Collection, Formatting, and Editing (MCFE) program 120, which creates an EP3 rich media container file 130 for playback and potential further manipulation on an end user rich media program 140. In its preferred embodiment, system 100 includes the present invention 120 and 130, representing the Media Collection, Formatting, and Editing (MCFE) program and the EP3 rich media container file respectively.

FIG. 2 represents a more detailed embodiment of the MCFE computer program 120 from FIG. 1, and depicts a flowchart illustrating the creation of EP3 rich media container files. While the flowchart and accompanying description emphasizes the creation of a ‘music-centric’ dotAlbum™, it should be noted that the present invention is intended to facilitate the media objects, sequencing, and formatting and editing required to create any custom compilation of rich media into a single container file (e.g., ‘dotLesson’ creation steps may include a song, video of an artist playing the song, and text representing sheet music for the song being played, among other content. While this is a variation on the creation of a dotAlbum™, the functions, features, and resulting EP3 file follow the same fundamental design and creative process).

Referring to FIG. 2, the iterative process of creating a rich media EP3 file begins with step 201, which is essentially opening up the MCEF creation program and determining in step 202 if there is digital content to add to a new or existing EP3 file. If the file is complete, steps 261 through 263 represent the final packaging and export process that culminates at step 264 in a new or re-published EP3 Rich Media file—in this case a ‘dotAlbum’.

If there is more content to add, steps 211 through 253 of FIG. 2 show the iterative process of adding or editing content for the EP3 Rich Media file. In general terms, for each class of media element (audio and video tracks, artwork, slide show images, web sites and other content), the creator of the EP3 file will initiate a file selection dialog relevant to the media element class. Media element classes are defined as a related set of file types. As an example, the audio track media element class includes Mp3, AAC, FLAC, Ogg and other types of files. Each file type has a unique identification as part of its file name. File selection dialogs are standard for each computer operating system. They allow a content creator to browse his file system to locate and select one or more files matching a file type specification which has been designed to include all file types relevant to a given media element class.

For some media element types, the EP3 creator will also provide parameters that govern how the element will be replayed by the end-user of the rich media package. It is assumed that the various media elements all reside in files and folders available to the EP3 creator's computer system, either on directly attached or network-attached, disk drives.

Note that FIG. 2 is just one representation of the preferred embodiment; other representations may show different steps and sequences of steps that are more applicable to the intended end usage of the EP3 file.

Starting with FIG. 3 and continuing through FIG. 7, some of the logical steps in the MCFE creation program are pictured in more detail.

For example, FIG. 3 represents part of the user interface for steps 211 through 213 of FIG. 2, otherwise known as Creating and Editing Audio and Video Tracks. During the creation and editing of audio and video tracks, a playlist graphical user interface supports the addition of audio and video tracks to the EP3 file. For each track to be included, the EP3 creator will request that a new track be “added” to the playlist. This will cause a file selection dialog to be opened, conditioned to display only digital audio and digital video file types. The EP3 creator will be allowed to browse his or her file systems to locate and select the relevant media file or files. Each file has associated information (metadata) that identifies the artist, album title and genre for the media. Once a media file has been added to the playlist, the EP3 creator may manually modify this metadata. Media files added in error may be deleted.

In FIG. 3, adding a track is initiated by clicking the “Add +” shown at the bottom left of the screen. Removing a track is initiated by highlighting (clicking on) the track in the playlist, then clicking the “Remove −” button. Metadata editing is initiated by clicking on the relevant field in the playlist display. These are working features of the MCFE program in a preferred embodiment, but they are not intended to represent the only way that such functionality may be presented to the user.

FIG. 4 represents part of the user interface for steps 221 through 223 of FIG. 2, otherwise known as Creating and Editing Slide Shows. During the creation and editing of slide shows, for each picture to be included, the EP3 file creator will request that a new image file be “added” to the slide show. This will cause a file selection dialog to be opened, conditioned to display only digital image types. The EP3 creator will be allowed to browse his file systems to locate and select the relevant image file or files. Once the image files have been added to the slide show, the EP3 creator may manually specify a background color, the length of time the image should be displayed and the type of transition to be used, among other specifications. Media files added in error may be deleted.

In FIG. 4, adding an image is initiated by clicking the “Add +” shown at the bottom left of the screen. Removing an image is initiated by highlighting (clicking on) the image in the slide show preview, then clicking the “Remove −” button. Display order, timing and background color are specified in fields at the bottom center of the slide show display.

FIG. 5 represents part of the user interface for steps 231 through 233 of FIG. 2, otherwise known as Creating and Editing Print Images (in this embodiment, the artwork used to print CD labels, jewel case inserts, and tray card inserts). For each supported print image type (in this embodiment, a jewel case insert, CD label, jewel case tray card insert and 2-page booklet), a print image may be included by initiating the image addition process. This will cause a file selection dialog to be opened, conditioned to only display image file types. The EP3 file creator will be allowed to browse his file systems to locate and select the relevant image file. Image files added in error may be deleted.

In FIG. 5, adding artwork is initiated by clicking on the relevant image. Removal is initiated by clicking the relevant “−” buttons shown at the bottom left of the screen. Note that this embodiment reflects images and artwork normally associated with music CD's. The present invention is intended to allow much broader usage, so for example, if the EP3 file is a ‘dotBOOK’, the user interface depicted in FIG. 5 would be tailored to book jackets, inner sleeves, book marks, and the like.

FIG. 6 represents part of the user interface for steps 241 through 246 of FIG. 2, otherwise known as Creating and Editing Web Sites. In this embodiment, a web site graphical user interface supports the addition of a set of liner notes and other web browser-based material to the EP3 file. Web sites may be internal or external. Internal web sites are referenced by their “home” folder on a user's file system. External web sites are referenced by their Universal Resource Locator (URL). An internal web site may be added by initiating a site addition dialog. This will cause a file selection dialog to be opened. The standard file selection dialog for the EP3 creator's computer operating system will be used, and the EP3 creator will be allowed to browse his file systems to locate and select the relevant media file. Web sites added in error may be deleted. A limited descriptive text may also be supplied to introduce the web site content.

In FIG. 6, adding a web site is initiated by either clicking the “Browse Disk” button, to add an internal site, or by clicking the “Paste URL” button to copy the site URL from the content creator's web browser. Removing a web site from the album is initiated by clicking the “Clear All” button.

All other relevant content, in particular, audio tracks, video tracks, images, text, internet links, or other relevant content, would be added or deleted along similar processes that are tailored by the expected end usage of the EP3 file. While these steps are generally noted in steps 251 through 253 of the FIG. 2, the user interfaces will vary and therefore are not depicted in this submission. However, the underlying program logic and resulting file structure remains similar to the steps represented by what is essentially a dotAlbum (music-centric EP3 file) in the current embodiment.

FIG. 7 represents part of the user interface for steps 261 through 263 of FIG. 2, otherwise known as the Create and Edit Overview. The user interface summarizes the content of the EP3 rich media package and provides for export to the external EP3 media file. In this embodiment, the album title and artist name metadata may be modified in this process. At the completion of the process, the EP3 specification is saved to a disk file for subsequent revision and packaging.

In FIG. 7, the album title and artist name are modified by clicking on the relevant field in the interface. In the preferred embodiment, several other labels and metadata descriptions will be available for customization, including, but not limited to, movie title, book title, lesson title, genre, release date, EP3 creator, etc.

The process is completed by clicking the “Done” button at the bottom of the display in FIG. 7. At the EP3 creator's request, when all of the media elements have been defined through the user interface, the data is written to a rich media file, either through clicking the “Publish Album” or “Export eMix” buttons (reflecting this current embodiment of a music-centric dotAlbum EP3 file). In the preferred embodiment, these functions would allow either commercial EP3 file creation where digital rights management controls any further manipulation of the content or EP3 file, or the export of a ‘non-commercial’ EP3 file with limited or no digital rights management attached. Either way, the resulting EP3 rich media file is saved to a specified location on the computer file system.

FIG. 8 refers to the general structure of the EP3 Rich Media Container files created by the Media Collection, Formatting and Editing (MCFE) program. The afore-mentioned EP3 file represents a single file containing multiple media objects integrated into a complete viewing and listening experience, and portable as one package across multiple computer, mobile, and other devices. EP3 files are intended to be both usage-centric (that is, the published EP3 files are dotAlbums (music-centric), dotMovies (movie-centric), dotBooks (reading-centric), etc.), as well as ‘perpetual’, that is, they have internet-based links that can be configured for automatic updates and communications between the end user, EP3 creator, artist, or any other third party, for as long as the dotAlbum or other EP3 representation exists.

Referring to FIG. 8, all EP3 files begin with a fixed length header allowing to correctly identify the file, which is then followed by a train of tagged blocks, each containing a train of tagged units, which in turn are comprised of strings and atoms.

Generally speaking, blocks in an EP3 file and units in data blocks can occur in any order. However, in the preferred embodiment, there are a four rules that are observed:

The EP3 header is always the first element in the file.

The End block is always the last block in the EP3 file.

The block header is always the first element in a block.

The End Unit is always the last unit in a block.

In the preferred embodiment, an EP3 file always starts with a fixed size header, followed by a sequential list of tagged blocks, as described in the following map:

EP3 file map

| Field | Type | Comment |
|---|---|---|
| Signature | ep3_ui32 | EP3 file signature. Must be equal to 0x33504551 |
| | | which is the little-endian ASCII representation of |
| | | ‘QEP3^{’}. |
| Major version | ep3_ui8 | File major version. The value corresponding to the |
| | | current specifications is 0x02. |
| Minor version | ep3_ui8 | File minor version. The value corresponding to the |
| | | current specifications is 0x00. |
| Reserved | ep3_ui8[10] | Space reserved for future use. |
| File Content | block[nb] | The content of the EP3 file: a sequential list of one |
| | | or more tagged data blocks (nb >= 1). |

All EP3 blocks share a common format, which allows different versions or different implementations of the present specifications to skip over blocks they don't understand. Each tagged block begins with the block tag, a unique identifier and the length of the block payload, which is formed by a train of block units.

The block Unit Identification (UID) can be used to ease the process of finding a block within an EP3 file. So for example, looking for a particular media block according to its UID can be done by simply reading block headers instead of having to parse the internal block units to find a matching predicate.

EP3 block map

| Field | Type | Comment |
|---|---|---|
| Block tag | ep3_ui16 | Tag ID allowing to clearly identify the block type |
| Block UID | ep3_ui16 | A numerical value which uniquely identifies the |
| | | block within the file. |
| Block length | ep3_ui32 | Size of the payload (in bytes). |
| Reserved | ep3_ui8[8] | Space reserved for future use. |
| Payload | unit[nu] | The block payload is made of a sequential list of |
| | | zero or more units (nu >= 0). |

A block unit stores an actual piece of information using zero or more EP3 atoms. This information is identified in the unit header by a tag and a type. The information atom(s) immediately follow(s) the header.

EP3 unit map

| Field | Type | Comment |
|---|---|---|
| Unit tag | ep3_ui8 | Tag ID allowing clear identification of the unit |
| | | type and its associated payload. |
| Unit atom | ep3_ui8 | The type of the atom. |
| type | | |
| Value | atom[na] | The unit value usually consists of a single EP3 |
| | | atom (na == 1) but can also contains no atom at |
| | | all (na == 0) or a sequential list of |
| | | identically typed atoms (na > 1). |

Having the atom type actually encoded in the file allows decoupling of the raw format itself from any changes made in the specification. Another useful side effect is that the size of the atom can be directly deduced from its type. The possible values for the type field in the preferred embodiment are the following:

Units atom types

| Type | Tag | Size |
|---|---|---|
| ep3_void | 0x01 | 0 |
| ep3_flag | 0x02 | 1 byte |
| ep3_ui8 | 0x03 | 1 byte |
| ep3_ui16 | 0x04 | 2 bytes |
| ep3_ui32 | 0x05 | 4 bytes |
| ep3_rgb | 0x07 | 3 bytes |
| ep3_string | 0x06 | n bytes of UTF-8 encoded characters (actual size |
| | | encoded in the first 4 bytes of the atom itself) |
| ep3_ui8[n] | 0xB0 | sequential list of n 8-bits values (total size encoded |
| | | in the first 4 bytes of the atom itself) |
| ep3_ui16[n] | 0xB1 | sequential list of n 16-bits values (total size in |
| | | bytes encoded in the first 4 bytes of the atom |
| | | itself) |

Integral Atoms: The EP3 file format uses unsigned 8-bits, 16-bits and 32-bits integer types stored using little-endian byte ordering: the least significant byte is stored first, and the most significant byte is stored last, in the same way as the Intel x86 architecture. For example, the 32-bits value 0x12345678 is stored as 0x78562312 and the 16-bits value 0x1234 is stored as 0x3412.

Integral atoms

| Atom | Comment |
|---|---|
| ep3_flag | Boolean flag. Can take |
| | two values: 0x00 as |
| | false and 0x01 as true. |
| ep3_ui8 | Unsigned 8-bits |
| | value. |
| ep3_ui16 | Unsigned 16-bits |
| | value. |
| ep3_ui32 | Unsigned 32-bits |
| | value. |
| ep3_ui8[n] | Sequential list of n |
| | 8-bits values, aka a |
| | binary blob. |
| ep3_ui16[n] | Sequential list of n |
| | 16-bits values. |

Composed Atoms: Integral atoms can combine to form composed atoms. While this would technically not make them atoms per se (just as molecules in chemistry are not atoms) they are still considered atoms for the purposes of this present invention because they have the same semantic role.

Strings: EP3 string atoms represent null terminated character strings based on the principles of Pascal strings; the format for a string value is a 4-byte value representing the string length followed by a sequential list of bytes, terminated by the null character. In the preferred embodiment, EP3 strings are stored using the Unicode UTF-8 encoding.

Strings

| Field | Type | Comment |
|---|---|---|
| Length | ep3_ui32 | String size (in bytes, including the termination |
| | | marker). |
| String | ep3_ui8[n] | Non-null string character UTF-8 encoded data. |
| Data | | |
| String End | ep3_ui8 | End of string marker. Always equal to 0x00. |

RGB Color: The RGB color atom represents a 24-bits color value with 8-bits red, green and blue components.

RGB color

| Field | Type | Comment |
|---|---|---|
| Red | ep3_ui8 | Red component, value goes between 0x00 and |
| | | 0xFF. |
| Green | ep3_ui8 | Green component, value goes between 0x00 and |
| | | 0xFF. |
| Blue | ep3_ui8 | Blue component, value goes between 0x00 and |
| | | 0xFF. |
| Alpha | ep3_ui8 | Alpha component, value goes between 0x00 and |
| | | 0xFF. |

As noted in the detailed description of this invention, EP3 Rich Media container files are intended to support multiple formats and types of media files. In the preferred embodiment, both the MCFE software program, and the resulting EP3 rich media file, supports but is not limited to, the following types of files: Audio files stored in a wide variety of formats, including:
Moving Picture Experts Group (MPEG) layer 1 and 2 MPEG
Audio Layer 3 (MP3)
Audio Codec 3 (AC-3)
Advanced Audio Coding (AAC)
Windows Media Audio (WMA) 1 and 2
Adaptive Differential Pulse-Code Modulation (ADPCM)
Ogg Vorbis
Ogg Free Lossless Audio Codec (FLAC)
Apple QuickTime Audio Format

Video files in a variety of formats, including:
MPEG layer 1, 2 and 4
Div/X
Sorenson Video CodecSVQ
Digital Video
Cinepak
Ogg Theora
International Telecommunication Union (ITU) H263 and H263i
Windows Media Video (WMV) 1 and 2
Intel Indeo

Photographic image slide shows consisting of digital still images in a variety of formats, including:
Joint Photographic Experts Group (JPEG)
JPEG File Interchange Format (JFIF)
Portable Network Graphics (PNG)
Tagged Image File Format (TIFF)
Bit Mapped Images

Local Web sites: As noted previously, the MCFE program and EP3 rich media file contain local web sites, used primarily to convey background information about the content of a rich media package. These local web sites, in their entirety, are contained within the EP3 file, and consist of a set of scripts and images that may be viewed using any standard web browser.

External Web Sites: Internet web sites are specified by their Universal Resource Locator's (URL's). The EP3 file does not contain the actual web site content, but rather, a reference to that content.

RSS Feeds: Really Simple Syndication (RSS) news feeds provide access to, and the ability to continually update, information about the media package content and its creator. RSS feeds are identified by a URL and are registered by the end-user's media player when the EP3 file is first encountered. A process within the media player periodically checks for updates to the feed and notifies the end-user when updates are available. In the preferred embodiment, RSS feeds are used as both a means of maintaining EP3 file content, and as a source of current news updates from the creator of the EP3 file.

It should be noted that the types of files or internet links supported by the present invention are not limited to those listed, and that the Media Collection, Formatting, and Editing (MCFE) program and the EP3 file format are both intended to easily handle additional types of media objects and formats.

Further Descriptions of EP3 Blocks & Units per the file types listed above: EP3 blocks are split in several families, identified by the block tag, each containing specific kinds of units, identified by their unit tag. This allows to group semantically equivalent pieces of data together which, while not being mandatory for the file format to work, is however recommended.

It should be noted that block units order is not fixed, and that they won't necessary appear in the same order than the one described in the following tables, which represent some of the file structures specific to a music-centric ‘dotAlbum’ EP3 container file.

Metadata

| Block tag: | | |
|---|---|---|
| 0x0100 | | |
| Tag | Type | Unit |
| 0x01 | ep3_string | Artist name |
| 0x02 | ep3_string | Title (of the album) |
| 0x03 | ep3_ui16 | Year |
| 0x04 | ep3_ui16 | Genre code, as defined in the ID3v1 specifications. |
| 0x05 | ep3_string | Genre description |
| 0x06 | ep3_ui16 | Cover picture UID |
| 0x07 | ep3_ui16 | Label picture UID |
| 0x08 | ep3_ui16 | Card tray insert picture UID |
| 0x0A | ep3_ui16 | Booklet picture UID |
| 0x09 | ep3_string | Main liner note index Universal Resource Locator |
| | | (URL), as descussed in WC3 RFC 3305. URLs |
| | | starting with http:// specify an external web |
| | | location, while URLs starting with ep3:// point to a |
| | | file embedded in the EP3 itself. |
| 0x0B | ep3_string | Main liner note preview text. |
| 0x11 | ep3_ui16 | Album duration (in seconds) |

Playlist

| Block tag: | | |
|---|---|---|
| 0x0101 | | |
| Tag | Type | Unit |
| 0x51 | ep3_ui16[n] | Sequential list of media UIDs which will determine |
| | | the playback order. |

Slideshow

| Block tag: | | |
|---|---|---|
| 0x0102 | | |
| Tag | Type | Unit |
| 0x61 | ep3_ui8 | Style: the EP3 specifications define four simple |
| | | transition styles which EP3 players should support: |
| | | Simple Cut: 0x01, Simple Fade: 0x02 (player |
| | | specific styles), Random: 0xED, Cycle: 0xEE |
| 0x64 | ep3_ui8 | Style variant. |
| 0x62 | ep3_ui8 | Play Mode Linear: 0x00, Random: 0x01 |
| 0x63 | ep3_color | Background color |
| 0x51 | ep3_ui16[2*n] | Sequential meshed list of picture UIDs which will |
| | | determine the order and duration of apparition of |
| | | images in the slideshow. Even (i) indices contain |
| | | the slide UID, odd (i + 1) indices contain the cor- |
| | | responding slide duration (in seconds). |

Picture

| Block tag: | | |
|---|---|---|
| 0x0201 | | |
| Tag | Type | Unit |
| 0xE1 | ep3_string | Filename |
| 0xEE | ep3_ui8 | LSDRM permission mask |
| 0xEF | ep3_ui8[n] | Data |

Liner Note

| Block tag: | | |
|---|---|---|
| 0x0202 | | |
| Tag | Type | Unit |
| 0xE1 | ep3_string | Universal Resource Identifier (URI), as defined in |
| | | W3C RFC3986. |
| 0xEF | ep3_ui8[n] | Data |

Media

| Block tag: | | |
|---|---|---|
| 0x020A | | |
| Tag | Type | Unit |
| 0x01 | ep3_string | Artist name |
| 0x02 | ep3_string | Media title |
| 0x10 | ep3_string | Album title (if different than the EP3 album title). |
| 0x11 | ep3_ui16 | Media duration (in seconds) |
| 0x04 | ep3_ui16 | Genre code, as defined in the ID3v1 aqnd ID3v2 |
| | | specifications from ID3.org. |
| 0x05 | ep3_string | Genre description |
| 0xE1 | ep3_string | File name |
| 0xEE | ep3_ui8 | LSDRM permission mask |
| 0xEF | ep3_ui8[n] | Data |

RSS News Feed

| Block tag: | | |
|---|---|---|
| 0x0401 | | |
| Tag | Type | Unit |
| 0X01 | ep3_string | RSS News feed Universal Resource Locator (URL) |
| | | to be registered with the user's integrated web |
| | | browser |
| 0X02 | ep3_ui16 | Update frequency (in minutes) |

Living Album RSS Feed

| Block tag: | | |
|---|---|---|
| 0x0402 | | |
| Tag | Type | Unit |
| 0X01 | ep3_string | Living Album RSS feed Universal Resource |
| | | Locator (URL). |
| 0X02 | ep3_ui16 | Update frequency (in minutes) |

The RSS feed data stream will contain the UID of the unit to be modified (added, deleted or replaced) and, if necessary, the replacement datga type and file.

| | | |
|---|---|---|
| End Block | | |
| Block tag: tag | | |
| 0xFFFF | | |
| Tag | Type | Unit |

The End block in the present embodiment is empty, but nothing prevents adding some useful units to it if necessary, such as a file checksum.

FIG. 9 is a pictorial representation of the digital rights management scheme (Less Stringent Digital Rights Management—LSDRM) contained in the EP3 file. Referring to FIG. 9, all EP3 media blocks (audio track, video track, cover image, slides and print images, etc.) carry a specific block unit which allows the content creator to define how those media may be externalized by the user.

The LSDRM block unit is one byte long (unit atom type is ep3_ui8) and acts as a mask of permission bits, as shown in FIG. 9. When the user initiates an action that would externalize media (rip, burn, unpack or upload), the EP3 player will verify the permission for each object to be externalized.

### ADVANTAGEOUS EFFECTS

The present invention is comprised of computer programs, file structures, and processes which allow the collection, formatting, editing, and packaging of digital media objects into a single file, rich media experience that can be customized by either the original publisher (creator) of the file and/or by the customer or user who receives the file. (The creator of the file may or may not be the same party that owns or licenses the content contained therein.) The invention allows the user to enjoy a pre-packaged rich media experience that includes integrated music, video, text, and any other media object that naturally ‘fits’ within the intended end experience. It also allows creators of these rich media files to both tailor the combination of objects to the individual consumer, as well as to manage the digital rights for the underlying content. In a preferred embodiment, a Record Label creates a rich media, digital ‘dotAlbum’ for sale to consumers through digital media stations at retail, home internet, or mobile devices. This ‘dotAlbum’ (specifically, the EP3 file in the present invention) contains music tracks, music video, slide shows from concerts, lyrics, liner notes, cover art, internet links to the artists' or label's website, promotional coupons, or any other digital content desired. The consumer in turn, receives a much higher valued entertainment experience, burnable on a disk or downloadable to their iPod, cell phone, thumbdrive, or actual computer, and, if so desired by the publisher or content provider(s), given the ability to customize the rich media file with the consumer's own music, photos, text, internet links, and other content. This new, comprehensive, and portable rich media experience and the formatting and editing program that creates it deliver in essence the “next CD”, or the “next DVD”, or the “next Textbook”, etc.—a brand new user experience far surpassing current representations of those media products

According to one aspect, the foregoing capability is provided to content licensors, publishers, consumers and retailers through a combination of a rich Media Collection, Formatting and Editing (MCFE) computer program, the EP3 rich media container file, and open source rich media player software—the latter of which has been demonstrated by the inventors but is not included in this submission, primarily because both the creation program and the container file are intended to work across all media players that adhere to certain standard media playback features already in common usage.

Preferably, the invention accomplishes the foregoing capability with minimal training for both creators and users of the rich media file, primarily through a simple, easy to use editing and formatting interface that walks the users through the items and questions consistent with the file's end usage, i.e., for a music-centric experience, a creator of the rich media file would be guided through music, cover art, video, liner notes, and other content selection in the context of creating a digital ‘dotAlbum’.

Another aspect of the invention is to provide publishers, retailers, content providers, and end users with the ability to easily customize the EP3 rich media file with their own brand names, promotions, internet links, and specific content—allowing them to remain connected in some way to the end user, potentially promote other products and services, and to customize the EP3 rich media file with their own personal content and messaging—perhaps to create a gift for a loved one.

It is also an aspect of the invention to enable content providers, publishers, and retailers to remain ‘connected’ with the end user for the life of the EP3 rich media file—creating a ‘living’ experience by linking the file to automatic, configurable updates of digital content through the internet. The analogy to this in the physical world is GM's OnStar® system that links GM cars to the manufacturer for various services throughout the life of the car.

It is a further aspect of the invention to enable the collection and packaging into a single file, rich media experience all known types and file formats of digital content, including music files, video files, text files, and the like, and combining and compressing these files into a compact, portable single computer file that can be unpacked and enjoyed across multiple listening and viewing devices. These devices would not be limited by their respective operating systems or form factor, and would include handheld media players, computers, cell phones, and any other device intended for the listening, viewing, and editing of digital content.

In addition to providing the capability to create and publish an EP3 rich media file portable across multiple platforms, the invention also separates the raw file format and content of the underlying media objects from the specifications for those objects, enabling the creator and user to change the sequence, types, and presentation of the media inside the EP3 rich media file without impacting the content itself.

Also, in order to facilitate digital rights management of the underlying content and to handle the various audio and video codecs for said content, both the Media Collection, Formatting, and Editing (MCFE) program and the EP3 rich media container file include the ability to track and control the digital rights for underlying content, and to support WMA, AAC, MP3 and other normally incompatible codecs.

An additional aspect of the invention is to provide a secure container for all rich media objects within it, in order to prevent unauthorized tampering, theft, or extraction unless agreed to and configured as such by the EP3 file publisher, content providers, or retailer.

A still further aspect of the invention is to include a run time version of an Open Source Media Player in conjunction with the delivery of the EP3 rich media file, providing an end user with the ability to enjoy the rich media experience regardless of what media player software they currently own.

It is also an aspect of the invention to provide consumers with the ability to print artwork, playlists, scene lists, liner notes, text, and any other applicable content from the EP3 rich media file.

In addition to the foregoing capability, the invention allows the extraction, re-editing, and re-publishing of content within an existing EP3 rich media file, dependent upon rights granted by the publisher or licensor of the content.

It is a further aspect of the foregoing capability to provide flexibility in the afore-mentioned ‘re-publishing’ of content. That is to say, that content licensors (such as Record Labels) would have the ability to ‘lock’ content that they provide, while still allowing consumers to ‘personalize’ that content by adding the consumer's own photos, music, video, and other content to the EP3 rich media file. For example, the end consumer may be able to add content to a purchased ‘dotAlbum’, or delete content from a purchased ‘dotAlbum’, but they would not be able to export and republish their resulting EP3 file without permission from the original licensors.

It is a still further aspect of the Media Collection, Formatting, and Editing (MCFE) program, and the run time Open Media Player, to leverage Open Source software for their foundation code, and through API's and custom software modules, to present different levels of functionality based upon either Basic ‘runtime’ usage or Professional ‘advanced editing and publishing’ usage—and potentially charging users based upon the respective features of the ‘Professional’ version software.

The combination of easy to use, ‘usage-centric’ media formatting and editing software, the advanced integration and compression techniques of the EP3 rich media file, and the accompanying run time Open Media Player software all facilitate the speed at which customized digital compilations of music, movies, books, and other rich media experiences are created, distributed, and enjoyed by the customer. The increase in possible content contained and integrated in the EP3 rich media file and the ease and speed of creating that combined package all facilitate a much more rapid and flexible distribution chain for published music, movies, and other entertainment. These aspects of the invention allow last minute changes to album, movie, and other releases without delaying the ‘street date’ for such releases—a significant problem in the world of physical distribution.

It is a further aspect of the invention to achieve the foregoing capabilities by means of integration with existing operating systems, file formats, compression/decompression algorithms, and media player software and devices, and to address the digital rights management concerns of content licensors while making the technical and legal complexities transparent to end users.

The present invention is intended to facilitate the easy and comprehensive selection, editing, and combination of multiple rich media content files and file formats—representing music, video, playlists, artwork, text, internet links, etc.—into a single, portable, digital rich media experience that can be enjoyed across all playing devices.

In its preferred embodiment, the Media Collection, Formatting, and Editing (MCFE) program creates EP3 rich media files that are centric to the usage intended. That is, music-oriented usage is created through a ‘dotAlbum’ that contains music, liner notes, playlists, cover art, concert footage, etc., while a ‘dotMovie’ may contain more emphasis on video, scene lists, theatre poster art, links to the actor biographies, and the like. In the preferred embodiment, there is no limit to this ‘usage-centric’ model. The media formatting and editing software, the resulting EP3 rich media file, and the Open Media Player software would all easily enable different combinations and playback of various content objects.

In its preferred embodiment, the new rich media experience created through the present invention will help shift the world of music, and to a broader extent movies, books, and other content, away from a single item, unbundled experience conducive to illegal file sharing, lower industry profits, and lower customer value, to a bundled, personalized, much higher valued experience that links the consumer to the publisher or artist forever—and by the nature of the customization, makes these personalized rich media experiences less likely to be illegally traded across the internet.

### DESCRIPTION OF DRAWINGS

These and other more detailed and specific features of the present invention are more fully disclosed in the following specification, reference being had to the accompanying drawings, in which:

FIG. 1 is a schematic diagram illustrating a system that integrates the collection, formatting, and editing of various rich media objects into one integrated EP3 file, for viewing and listening on an end-user rich media program

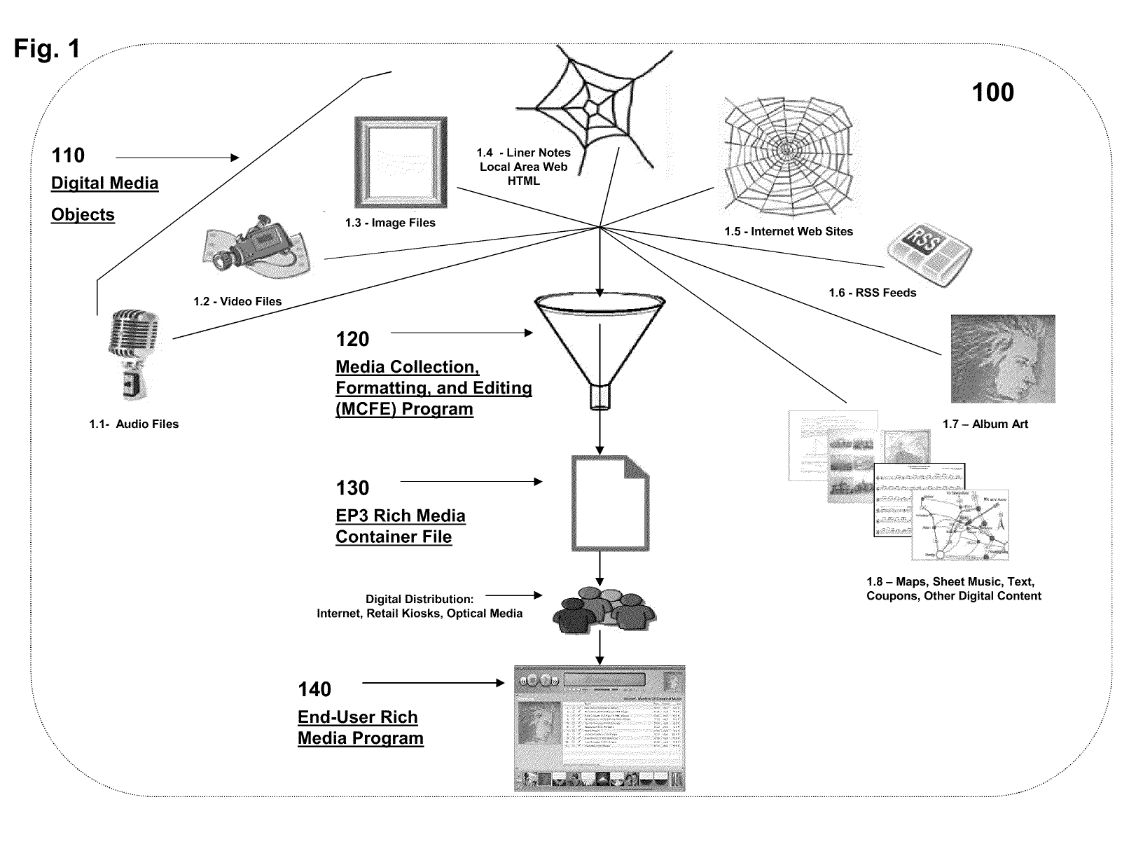

FIG. 2 is a flow chart illustrating an embodiment of the Media Collection, Formatting, and Editing (MCFE) Program, in this instance reflecting the creation of a music-centric ‘dotAlbum’ EP3 file.

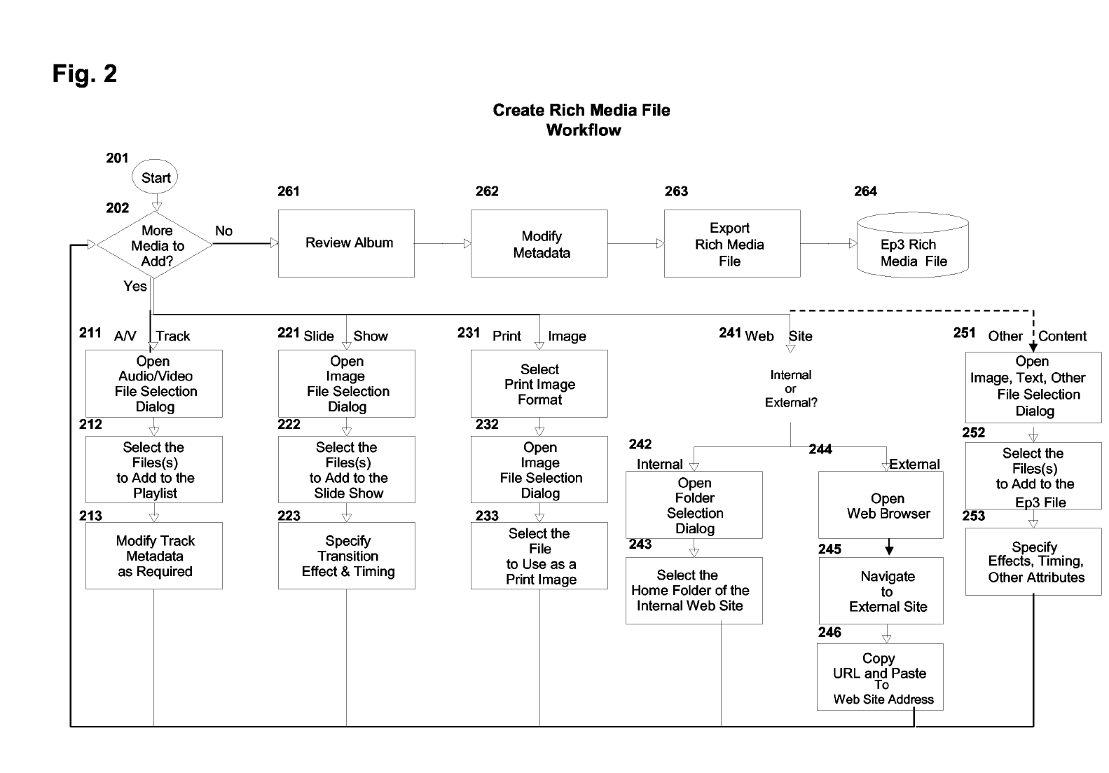

FIG. 3 is a graphical representation of the user interface for creation and editing of audio and video tracks within the Media Collection, Formatting, and Editing (MCFE) Program

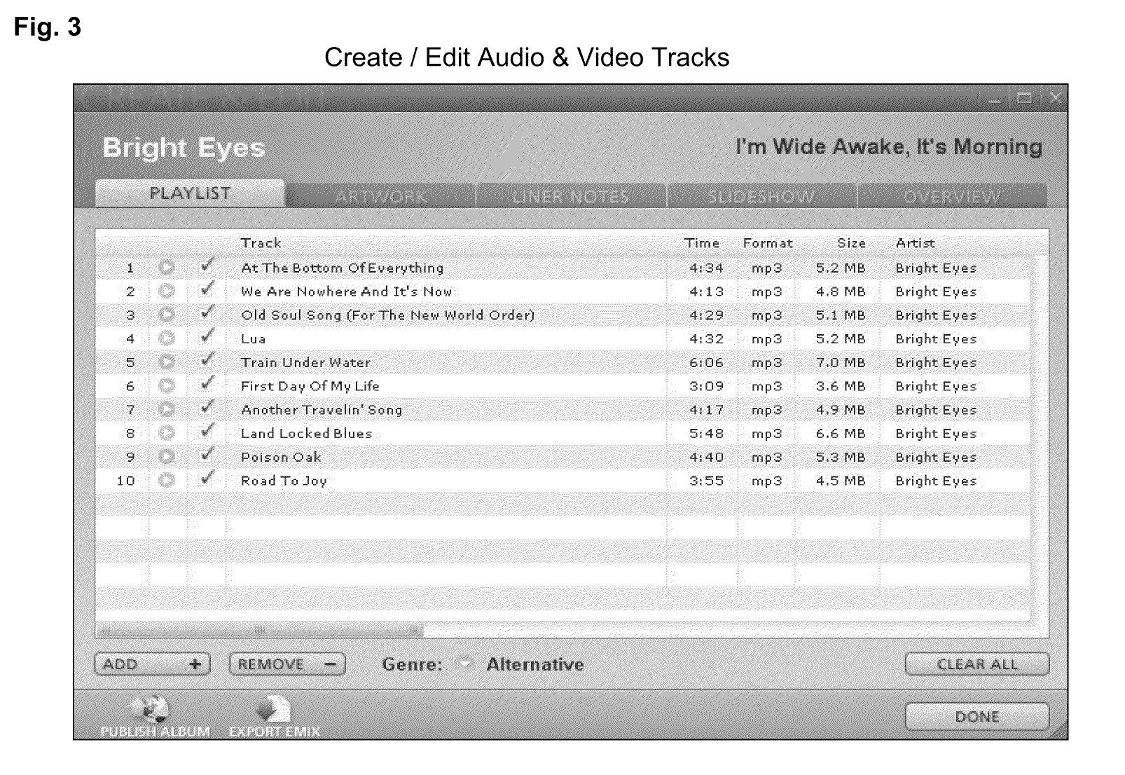

FIG. 4 is a graphical representation of the user interface for the creation and editing of slide shows within the Media Collection, Formatting, and Editing (MCFE) Program

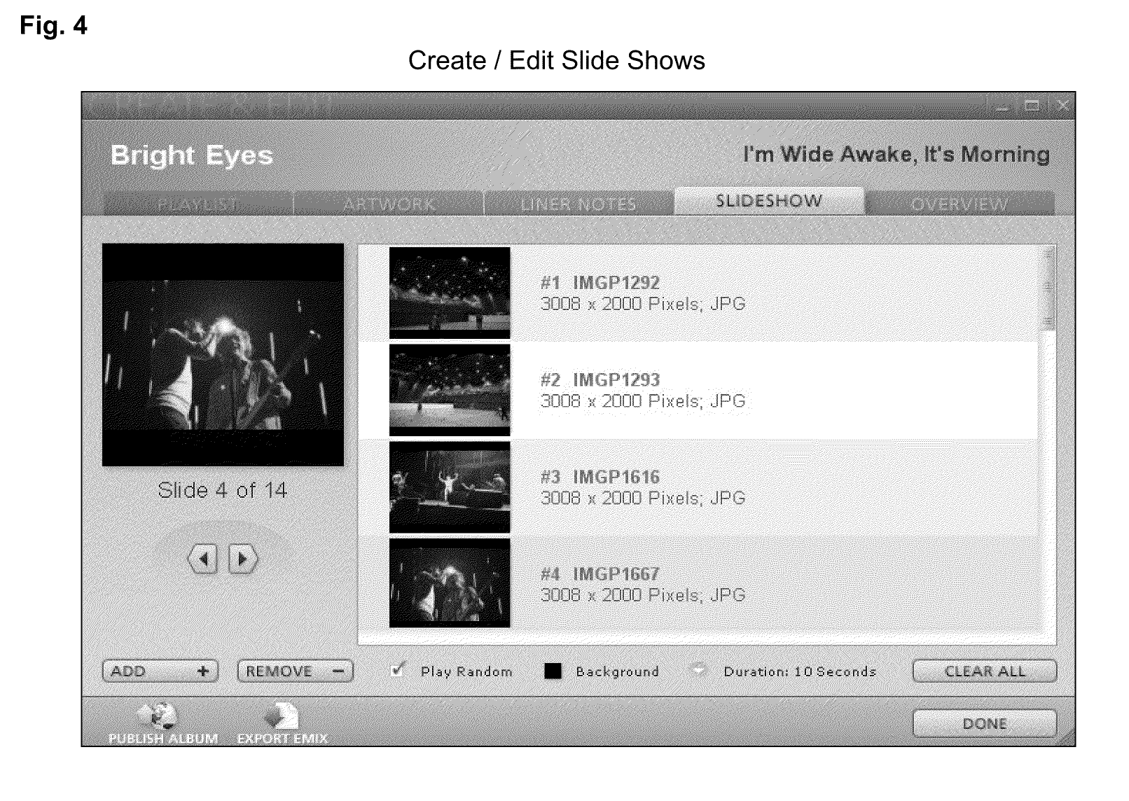

FIG. 5 is a graphical representation of the user interface for creation and editing of print images within the Media Collection, Formatting, and Editing (MCFE) Program

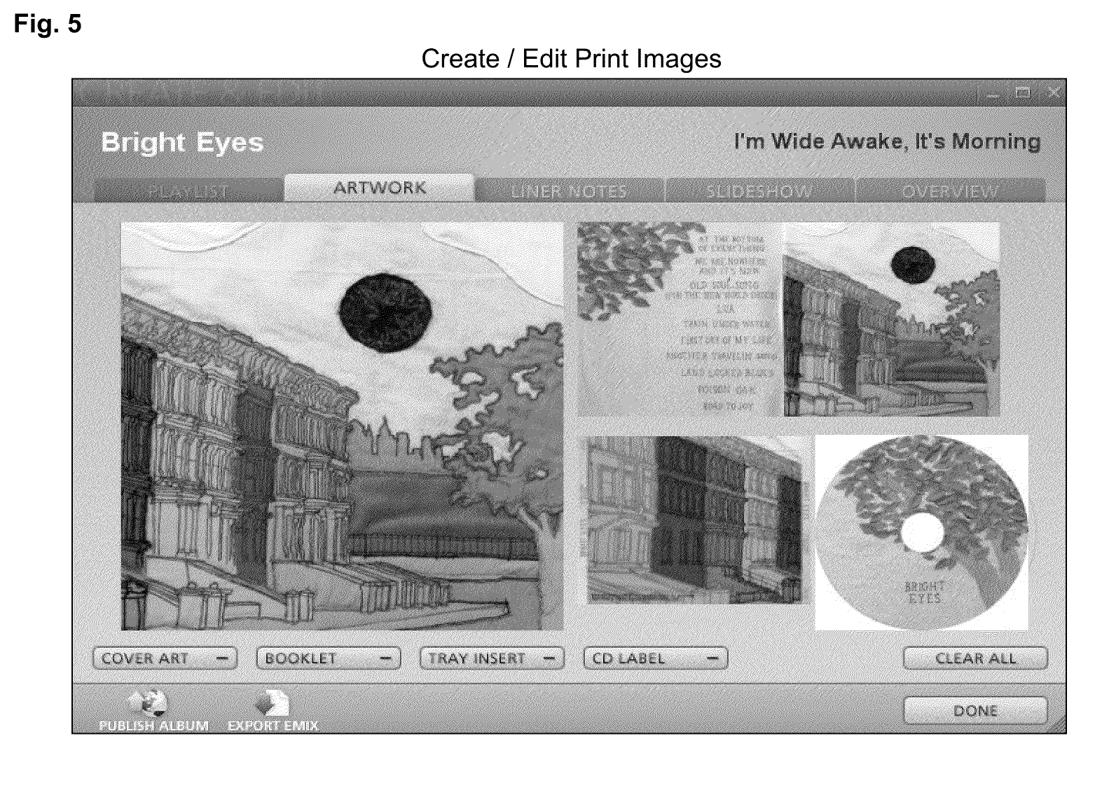

FIG. 6 is a graphical representation of the user interface for creation and editing of web sites within the Media Collection, Formatting and Editing (MCFE) Program

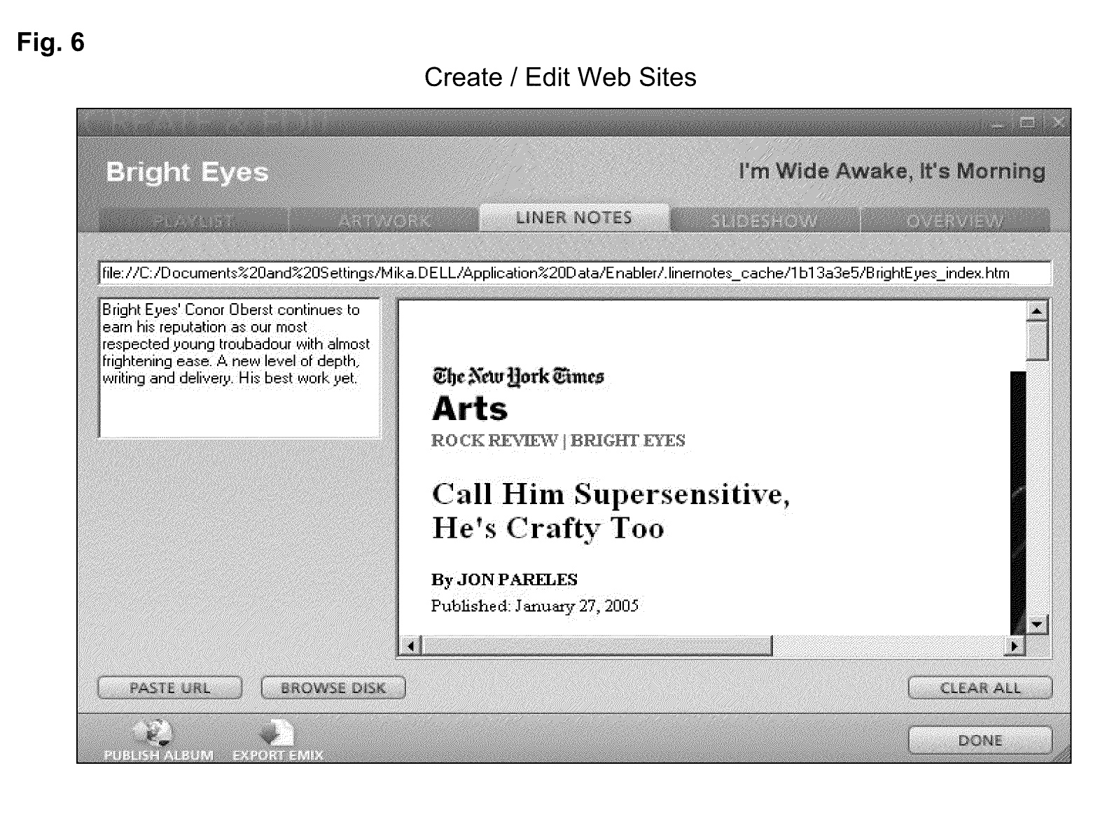

FIG. 7 is a graphical representation of the user interface summarizing the content of the rich media package and provision for export to the external EP3 file.

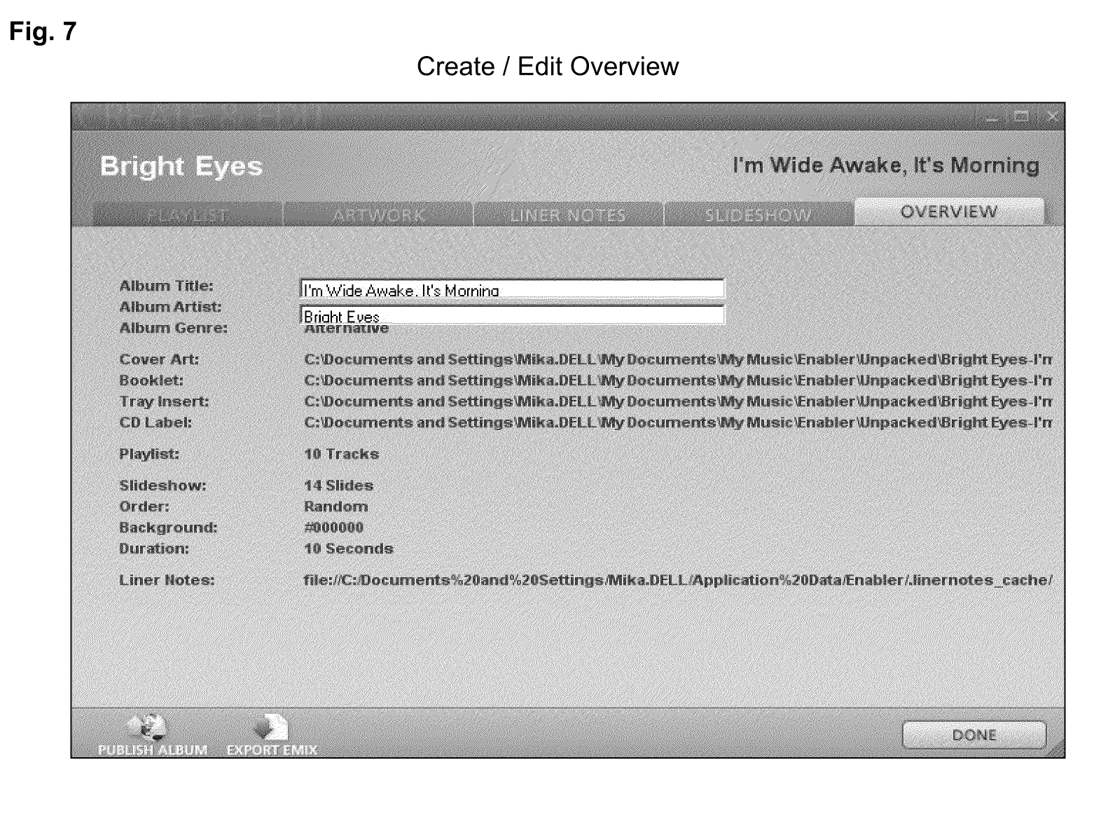

FIG. 8 is a pictorial representation of the internal file structure of the EP3 rich media file.

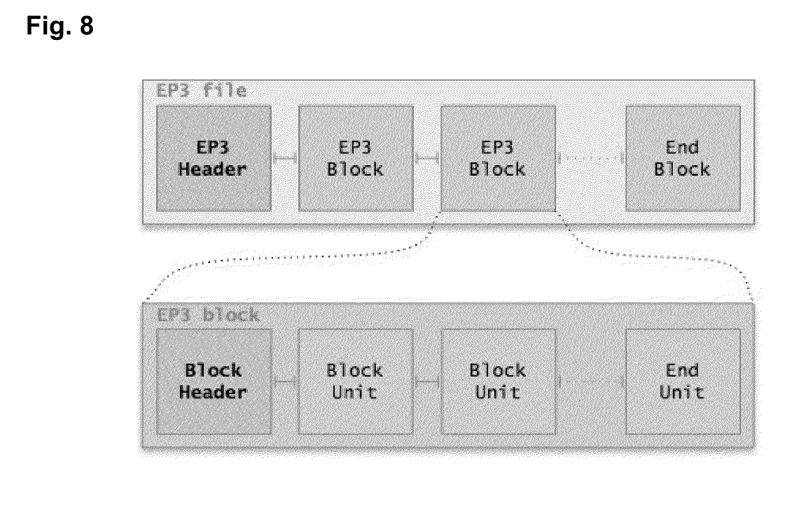

FIG. 9 is a pictorial representation of the digital rights management scheme (Less Stringent Digital Rights Management—LSDRM) contained in the EP3 file.

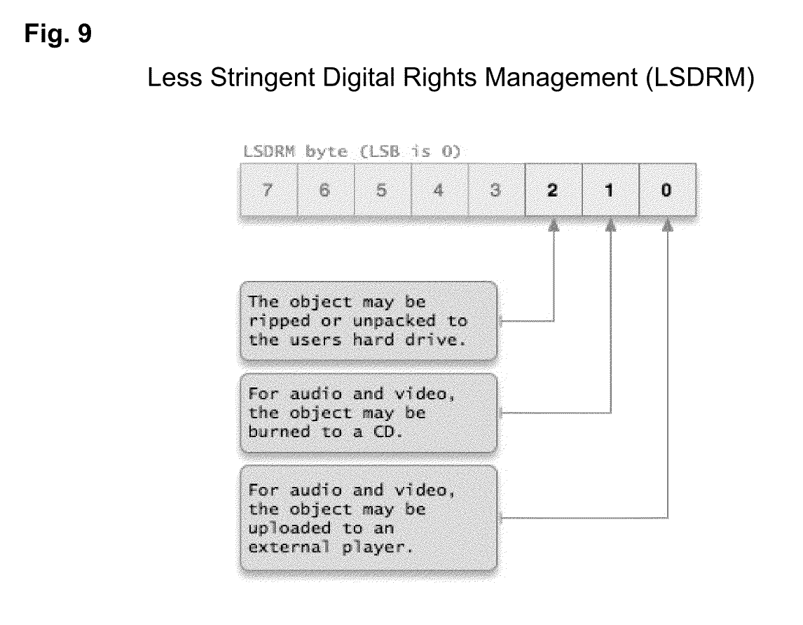

FIG. 10 is a schematic for a generic Open Media Player that could be used to render the EP3 file for viewing and listening.

FIG. 11 is a graphical representation of the user interface for a working prototype Open Media Player that supports the rich media EP3 format.

FIG. 12 is a graphical representation of the user interface for the web site viewer within the working prototype Open Media Player.

FIG. 13 is a graphical representation of the user interface for the video display mode within the working prototype Open Media Player.

### BEST MODE

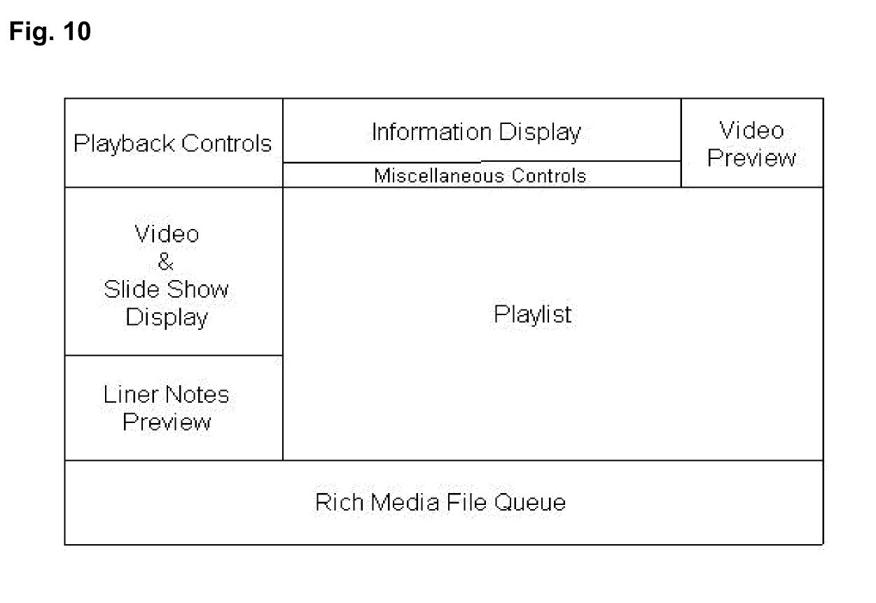

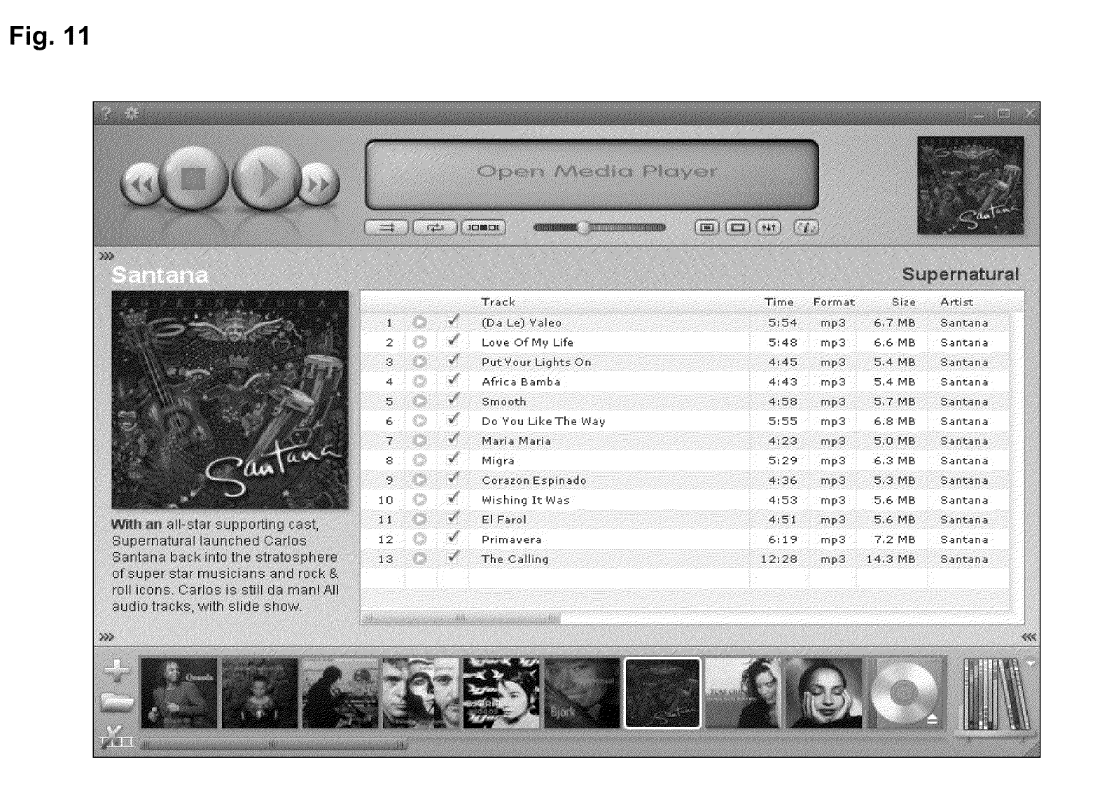

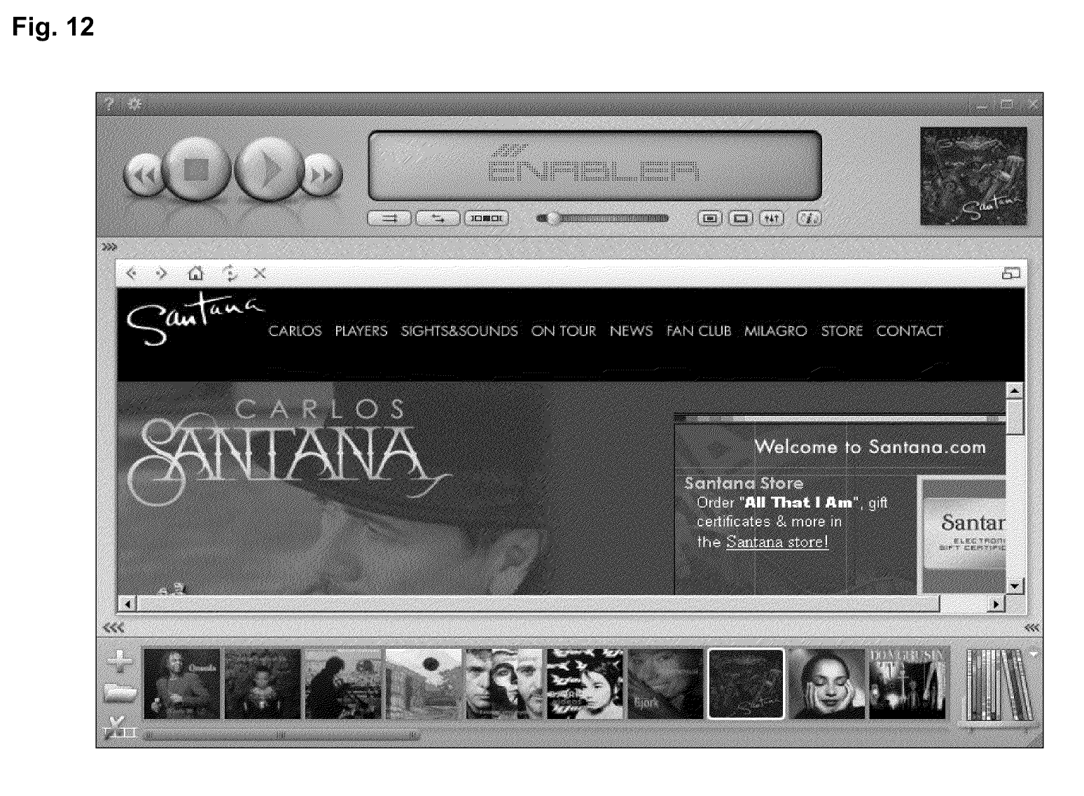

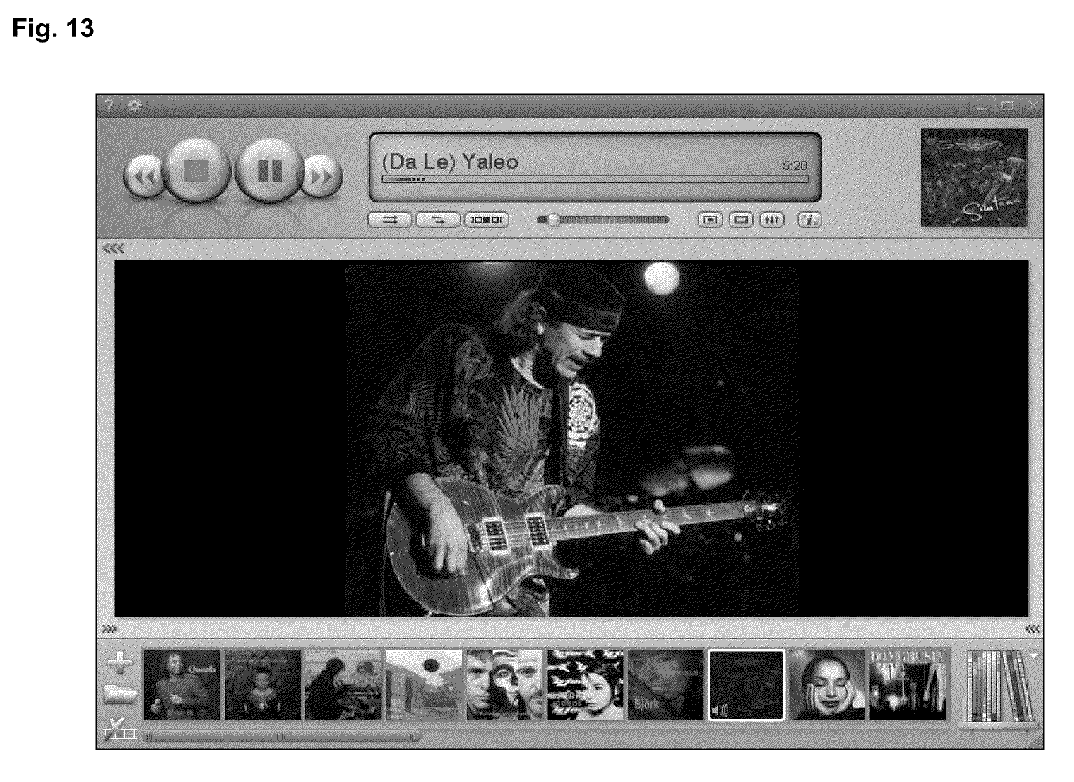

FIG. 10 is a schematic for a generic Rich Media Player that could be used to render the EP3 file for viewing and listening. It is intended that any number of media players be enabled to play the EP3 rich media format. Initially, the capability is demonstrable in the Open Media Player prototype that is depicted in FIG. 11, FIG. 12, and FIG. 13, but that is not part of this submission. The requirements for any media player wishing to fully support the EP3 format are as follows:
General ability to output audio data
General ability to output video data with synchronized audio
Integrated web browser supporting live bookmarks
Integrated image viewer
At a minimum, a rich media player must support audio data output.

A representative player could be organized into the general components as depicted in FIG. 10.

For currently playing objects, the user might view or listen to the tracks in the rich media album object while editing the contents of another object. In the Open Media Player prototype, the following are available for the currently playing rich media album:
Playback Controls. Play, pause, resume and track selection controls.
Information Display. Metadata for the currently playing track.
Miscellaneous Controls. Volume and mix controls.
Album Cover Preview. Album cover art display.

While these features are demonstrable in the Open Media Player, and on other Media Players, this is not an exhaustive list and is intended only to represent possible functions and features of media players in common usage.

For a Currently Selected Rich Media EP3 file (in this case, a dotAlbum, a user might do the following:
Video & Slide Show Preview. The area can be expanded to view a larger image.
Playlist Preview. A list of the tracks in the currently selected rich media album.
Liner Notes Preview. A summary of the liner notes for the album. The area may be expanded to display the complete set of liner notes, as well as the content of any other web site defined in the rich media package.

Through the Open Media Player, and other media players, the user may also view a list of all of the rich media files registered with to the player

In the preferred embodiment, when an EP3 rich media file is first opened by the player, a list of the media elements in the file is extracted and written to a local database to facilitate subsequent use. Any RSS feeds specified in the file are further registered with a feed rendering engine that periodically checks the feed site for information updates. RSS feed viewing is facilitated through a standard web browser tool.

Referring to FIG. 11, a working prototype of a play-back software application that supports the rich media EP3 file is shown. Each area of the display can be expanded to show the content more fully FIG. 12 is a graphical representation of the user interface for the web site viewer within the working prototype Open Media Player, and FIG. 13 is a graphical representation of the user interface for the video display mode within the Open Media Player.

As previously noted, the prototype Open Media Player is not part of this submission because the software plug ins and any other ‘adaptors’ required to support the EP3 file format are included as part of the MCFE software that is already included in this invention.

Thus embodiments of the present invention produce and provide a process, format, and computer software for collecting a broad range of digital media objects, and storing them in a single, rich media container file, for simplified distribution and integrated playback. They create a much richer music, video, and other entertainment experience that can be customized by both the creator and the user, and that can be electronically distributed across multiple computers, mobile devices, and other platforms. The process and computer program for creating the rich media file also embeds digital rights management of the underlying content, and enables a ‘perpetual link’ between the user and the artist or any third party for the life of the content. Although the present invention has been described in considerable detail with reference to certain embodiments thereof, the invention may be variously embodied without departing from the spirit or scope of the invention. Therefore, the following claims should not be limited to the description of the embodiments contained herein in any way.

1.-28. (canceled)

29. A method for use in at least one of generating and editing a single rich media file, comprising:
first identifying, via a user device, a plurality of digital media objects each being of one of the following types: audio files, video files, graphic or photographic images, web sites and RSS feeds, wherein the plurality of digital media objects include objects of at least two different ones of said types;
retrieving the plurality of digital media objects in response to the first identifying step; and
using an integrated media packaging tool to write the plurality of digital media objects to a single rich media file, wherein the single rich media file is adapted for manipulation as a single unit by an application, said manipulation including at least one of transmitting said rich media file across a network and changing the digital media objects included in said rich media file.

30. The method of claim 29, further comprising:
second identifying digital rights in relation to at least one of the plurality of digital media objects; and
incorporating specifications for controlling use of the rich media file in accordance with the digital rights into the single rich media file.

31. The method of claim 29, further comprising:
linking the single rich media file to at least one web site.

32. The method of claim 29, wherein the retrieving step further comprises:
retrieving one of the plurality of digital media objects from a first location and another of the digital media objects from a second location, wherein the first location is resident on the computing device and the second location is in communication with the computing device via at least one data network.

33. The method of claim 29, further comprising:
compressing the rich media file before further use and/or transmission of the rich media file.

34. The method of claim 29, wherein the application comprises a rich media player that is operable to render the single rich media file for viewing and/or listening by at least one user.

35. The method of claim 29, wherein the single rich media file comprises a plurality of blocks, each block containing at least one digital media object.

36. The method of claim 35, wherein each block comprises a plurality of units, each unit containing a portion of the at least one digital media object.

37. The method of claim 35, wherein the plurality of blocks are arranged in a preference order.

38. The method of claim 37, further comprising:
adjusting the preference order using the application.

39. The method of claim 29, further comprising before the first identifying step:
selecting a particular intended usage of a forthcoming generated or edited single rich media file.

40. The method of claim 39, wherein the digital media objects selected in the first identifying step correspond to the particular intended usage.

41. The method of claim 39, wherein the particular intended usage corresponds to one selected from the group consisting of music, graphics, video, instruction and reading.

42. A system for use in generating and/or editing a single rich media file, comprising:
a file retrieval module for retrieving a plurality of digital media objects, wherein each of the plurality of digital media objects is of one of the following types: audio files, video files, graphic or photographic images, web sites and RSS feeds, wherein the plurality of digital media objects include objects of at least two different ones of said types; and
an integrated media packaging tool for writing the plurality of digital media objects to a single rich media file adapted for manipulation as a single unit by an application, said manipulation including at least one of transmitting said rich media file across a network and changing the digital media objects included in said single rich media file.

43. The system of claim 42, further comprising:
an interface module for allowing control of the file retrieval module and the integrated medial packaging tool.

44. The system of claim 43, wherein the interface module is operable to display at least one graphical user interface on one or more computing devices.

45. The system of claim 44, wherein the graphical user interface comprises:
a first region including a plurality of user manipulable features; and
a second region that is operable to provide a display associated with one or more types of digital media objects.

46. The system of claim 45, wherein the plurality of user manipulable features of the first region features allows for the addition and subtraction of one or more digital media objects.

47. The system of claim 46, wherein the graphical user interface comprises:
a third region including a plurality of user manipulable features that are operable to select the one or more types of digital media objects displayed in the second region.

48. The system of claim 45, wherein the plurality of user manipulable features of the first region features allow for the creation of the single rich media file.

49. The system of claim 45, wherein the plurality of user manipulable features of the first region features allow for the selection of an intended usage of the single rich media file, wherein upon selection of a first intended usage of the single rich media file, the second region is operable to provide a display associated with digital media objects corresponding to the intended usage.

50. The system of claim 42, further comprising:
a file manager that is operable to provide an indication of digital media objects available to be retrieved by the file retrieval module for incorporation into the single rich media file by the integrated media packaging tool.

51. The system of claim 42, wherein the integrated media packaging tool comprises:
a manipulation control module operative to control manipulation of one or more digital media objects of the single rich media file.

52. The system of claim 51, wherein the manipulation control module is operative to modify metadata associated with one or more of the digital media objects of the single rich media file to indicate a desired level of manipulation of the one or more digital media objects.

53. A method for use in playing media content, comprising the steps of:
accessing, using a player resident on a host platform, a single rich media file incorporating first and second media objects of first and second different media types, each of the media types being one of an audio file, a video file, a graphic or photographic image file, a web site and an RSS feed; and
rendering at least one of the first and second digital media objects to a user via the host platform using the player.

54. The method of claim 53, further comprising before the rendering step:
extracting each of the first and second media objects from the single rich media file.

55. The method of claim 54, further comprising:
writing each of the first and second media objects to a local database.

56. The method of claim 53, further comprising:
recognizing a type of at least one of the first and second media objects, wherein the rendering step includes using a rendering tool associated with the type of the at least one of the first and second media objects.

57. The method of claim 56, wherein the recognizing step further includes:
reading metadata associated with the one of the first and second media objects.

58. The method of claim 53, further comprising:
decompressing the first and second digital media objects.

59. The method of claim 53, further comprising:
determining a use or manipulation level of each of the first and second media objects, wherein the rendering step proceeds in accordance with the determined use or manipulation level.

60. The method of claim 59, wherein the determined use or manipulation level comprises digital rights associated with each of the first and second media objects.

61. A system for use in playing media content, comprising:
a file access module for accessing a single rich media file, the single rich media file including a plurality of media objects each being one of the following types: audio files, video files, graphic or photographic images, web sites and RSS feeds, wherein the plurality of media objects include media objects of at least two different ones of said types; and
at least one rendering tool for presenting the plurality of media objects to a user for listening and/or viewing.

62. The system of claim 61, further comprising:
an extraction module for extracting each of the plurality of media objects from the single rich media file, wherein the at least one rendering tool presents the plurality of extracted media objects to the user.

63. The system of claim 61, further comprising:
a media object type recognition module operable to determine the type of at least one of the plurality of media objects, the type being one of the following types: audio files, video files, graphic and photographic images, web sites and RSS feeds, wherein the at least one rendering tool is associated with the type of the at least one of the plurality of digital media objects.

64. The system of claim 61, further comprising:
a decompression module for decompressing each of the plurality of media objects.

65. The system of claim 61, further comprising:
a manipulation level module operable to determine a use or manipulation level of each of the plurality of media objects, wherein the at least one rendering tool presents the plurality of media objects for listening and/or viewing in accordance with the determined use or manipulation level.

66. The system of claim 65, wherein the use or manipulation level comprises digital rights associated with each of the plurality of media objects.

67. The system of claim 61, wherein the at least one rendering tool is operable to, for at least one of the plurality of media objects, output video data with synchronized audio data.

68. The system of claim 61, further comprising:
at least one web browser.

69. The system of claim 68, wherein the at least one web browser supports live bookmarks.

70. A computer readable storage structure containing a plurality of media objects integrated into a single rich media file, the plurality of media objects including at least two different ones of an audio file, a video file, a graphic or photographic image file, a web site and an RSS feed, the single rich media file including:
a header for identifying the single rich media file; and
a plurality of blocks, each of the blocks containing one of the plurality of media objects.

71. The storage structure of claim 70, wherein the header has a predetermined length specified by a standard protocol for said rich media file.

72. The storage structure of claim 70, wherein each block comprises a plurality of units, wherein at least one of the plurality of units contains a portion of the one of the plurality of media objects.

73. The storage structure of claim 72, wherein each block comprises a block unit identifier contained within a block header for identifying the block.

74. The storage structure of claim 72, wherein each of the plurality of units comprises one or more atoms, each atom including a number of bits.

75. The storage structure of claim 72, wherein at least one of the plurality of units comprises data indicating an externalization level of the one of the plurality of media objects.

76. The storage structure of claim 75, wherein the externalization level includes at least one of ripping, burning, unpacking and uploading the one of the plurality of media objects.
